(19) United States
(12) Patent Application Publication
(10) Pub. No.: US 2012/0024931 A1
(43) Pub. Date: Feb. 2, 2012

(54) SADDLE STAPLER

(76) Inventor: Chun Yuan Chang, Taipei (TW)

(21) Appl. No.: 12/845,774

(22) Filed: Jul. 29, 2010

(51) Int. Cl. B25C 5/11

(52) U.S. Cl. 227/120

(57) ABSTRACT

A addle stapler contains a base including a bottom abutting section formed on a bottom end thereof, a top arm section bently extending from one end of the bottom abutting section, a support section obliquely extending upward from another end of the bottom abutting section; a filling mechanism fixed on an edge of the top arm section of the base to receive at least one type of and one staple, and the staple being forced by pressing the filling mechanism so that it is pushed outward from an outlet of the filling mechanism; a quick removing disassembly mounted on the support section of the base, and including a horizontal slot and at least one positioning projection; a ruler including a scale defined thereon, the scale includes a number of standard scale codes of papers, and the ruler also including at least one orifice.

### BACKGROUND OF THE INVENTION

1. Field of the Invention

The present invention relates to a stapler, and more particularly to a saddle stapler that is assembled and dissembled quickly.

2. Description of the Prior Art

Referring to FIG. 1, a conventional stapler includes a base 1, a ruler 2, and a filling mechanism 3, wherein the base 1 is bent at a predetermined angle to define a bottom abutting section 4 formed on a bottom end thereof, a top arm section 5 above the bottom abutting section 4, and the bottom abutting section 4 is used to put the stapler on a plane, the ruler 2 is connected on a free end of the bottom abutting section 4, and the filling mechanism 3 is disposed on a free end of the top arm section 5, the ruler 2 includes a disassembling trench 7 arranged thereon in response to an outlet 6 of the filling mechanism 3, such that a receiving space is formed between the bottom abutting section 4 and the top arm section 5 to insert a paper, and the ruler 2 also includes a scale 8 to align the paper with the scale 8 so as to fix a staple at a central position of the paper, thus folding the paper into two parts evenly to make a book.

However, the ruler 2 of such a conventional stapler is fixed on the bottom abutting section 4 of the base 1, therefore when desiring to fixing the staple on a peripheral side of the paper, the ruler 2 is not used but interface the stapling process. Likewise, the ruler 2 can not be disassembled from the stapler to occupy store space and is not portable easily due to its large size.

The present invention has arisen to mitigate and/or obviate the afore-described disadvantages.

### SUMMARY OF THE INVENTION

The primary object of the present invention is to provide a saddle stapler of which the ruler is assembled with and disassembled from the quick removing assembly quickly to lower store space and size and to be portable easily.

To obtain the above objective, a saddle stapler contains:

a base including a bottom abutting section formed on a bottom end thereof, a top arm section bently extending from one end of the bottom abutting section, a support section obliquely extending upward from another end of the bottom abutting section;

a filling mechanism fixed on an edge of the top arm section of the base to receive at least one type of and one staple, and the staple being forced by pressing the filling mechanism so that it is pushed outward from an outlet of the filling mechanism;

a quick removing disassembly mounted on the support section of the base, and including a horizontal slot and at least one positioning projection;

a ruler including a scale defined thereon, the scale includes a number of standard scale codes of papers, and the ruler also including at least one orifice, the ruler being inserted into the horizontal slot of the quick removing assembly so that the positioning projections retain in the orifices of the ruler, and the ruler being removed from the horizontal slot of the quick removing assembly so that a positioning projections disengage from the orifices of the ruler.

### BRIEF DESCRIPTION OF THE DRAWINGS

FIG. 1 is a perspective view of a conventional stapler;

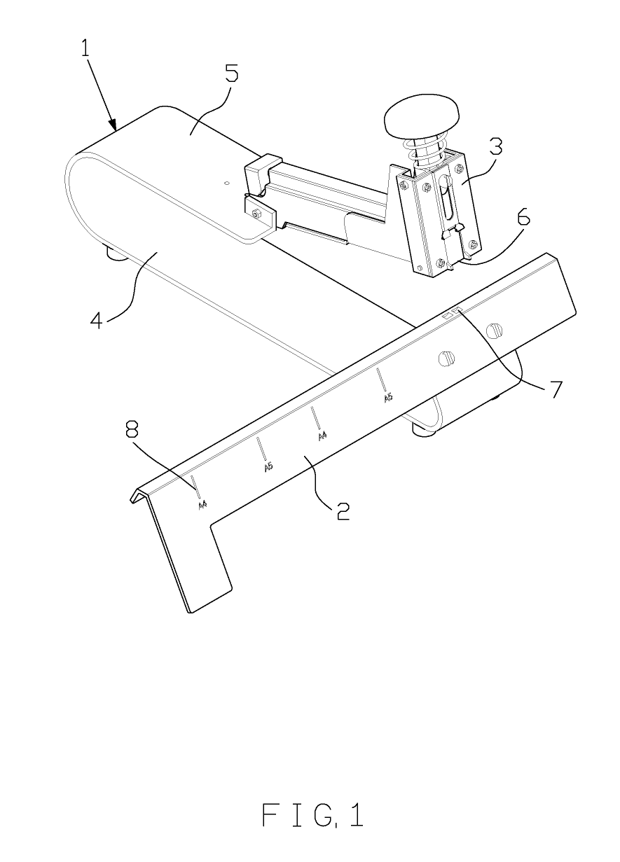

FIG. 2 is a perspective view showing the exploded components of a saddle stapler according to a preferred embodiment of the present;

FIG. 3 is a perspective view showing the assembly of the saddle stapler according to the preferred embodiment of the present;

FIG. 4 is a cross section view showing a part of the assembly of the saddle stapler according to the preferred embodiment of the present;

FIG. 5 is a perspective view showing the operation of the saddle stapler according to the preferred embodiment of the present;

FIG. 6 is another perspective view showing the operation of the saddle stapler according to the preferred embodiment of the present;

FIG. 7 is another perspective view showing the operation of the saddle stapler according to the preferred embodiment of the present.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

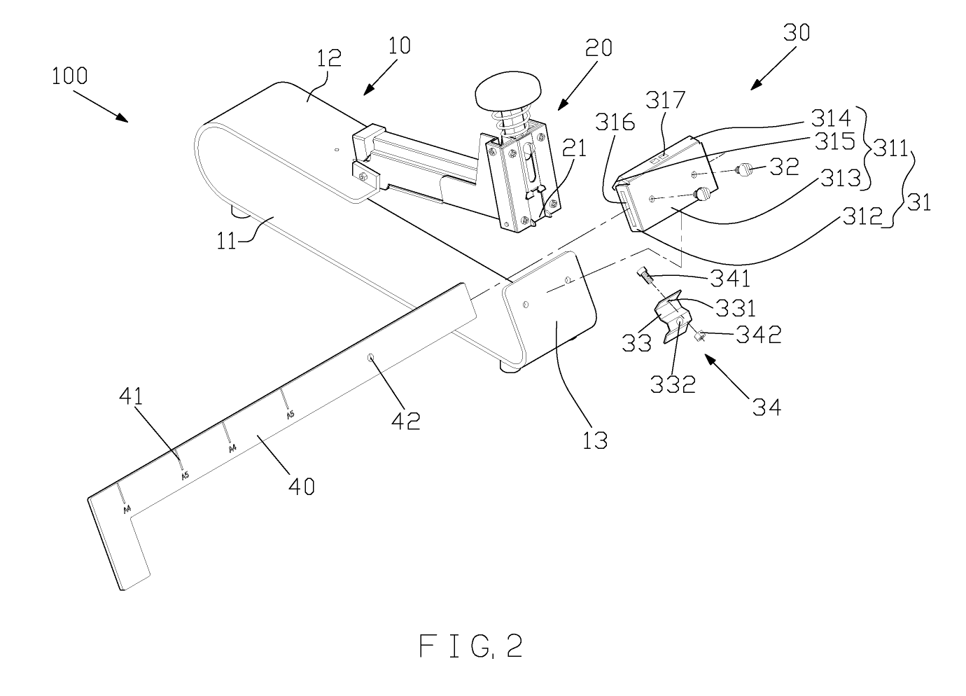

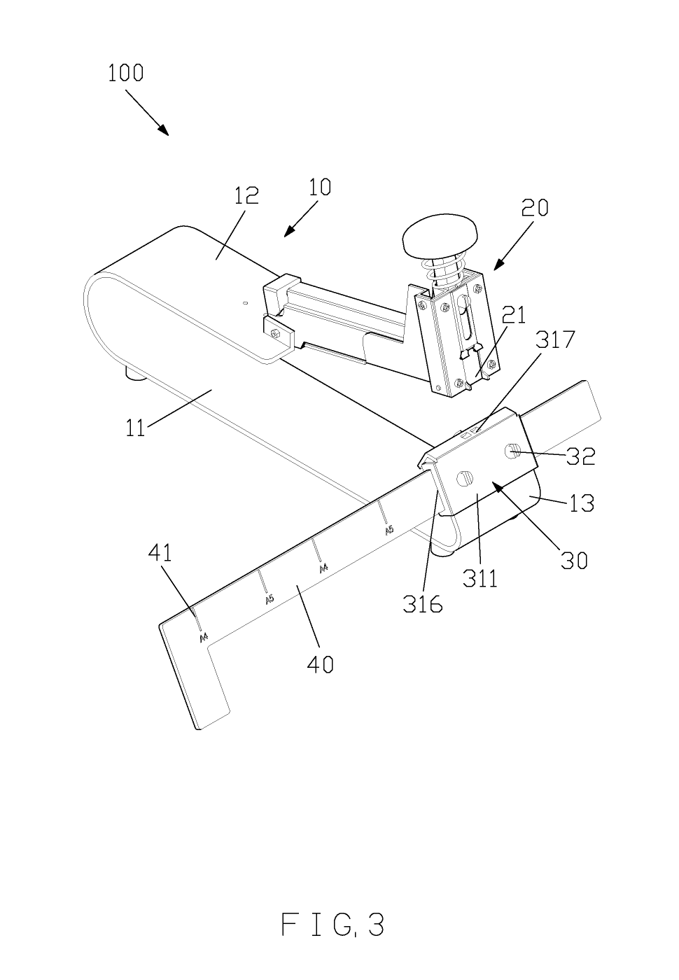

Referring to FIGS. 2-7, a saddle stapler 100 in accordance with a preferred embodiment of the present invention comprises a base 10, a filling mechanism 20, a quick removing assembly 30, and a ruler 40.

As shown in FIGS. 2-4, the base 10 is integrally made of a rigid and flexible plate, and includes a bottom abutting section 11 formed on a bottom end thereof, a top arm section 12 bently extending from one end of the bottom abutting section 11, a support section 13 obliquely extending upward from another end of the bottom abutting section 11, wherein the bottom abutting section 11 and the top arm section 12 are parallel to each other and spaced away from a certain distance, and the bottom abutting section 11 is use to put the base 10 on a plane securely.

The filling mechanism 20 is fixed on an edge of the top arm section 12 of the base 10 to receive at least one type of and one staple, the staple is forced by pressing the filling mechanism 20 (not shown) so that it is pushed outward from an outlet 21 of the filling mechanism 20. Since the filing mechanism 20 is well-known prior art, further remark is omitted.

The quick removing disassembly 30 is mounted on the support section 13 of the base 10 to provide a remove groove to bend the staple and to position or remove the ruler 40 in a quick sliding manner.

The quick removing assembly 30 includes a connecting member 31, two screwing elements 32, a resilient piece 33, and a locking unit 34. The connecting member 31 includes a panel 311 and two filling blocks 312, and the panel 311 is bent at a predetermined angle to define a first coupling section 313, a disassembling section 314, and a second coupling section 315, the disassembling section 314 is connected between the first coupling section 313 and the second coupling section 315 at a predetermined included angle, and the fitting blocks 312 are connected on an inner surface of the first coupling section 313 and spaced apart from each other at a predetermined distance, each fitting block 312 includes a horizontal slot 316, the first coupling section 313 is disposed on the support section 13 of the base 10 by using the screwing elements 32, and the disassembling section 314 includes a recess 317 to remove the staple formed on an outer surface thereof in response to the outlet 21 of the filling mechanism 20, the second coupling section 315 includes a hole 318 arranged thereon, and the resilient piece 33 includes a fixing bore 331 and at least one positioning projection 332, the locking unit 34 includes a bolt 341 and a nut 342, the bolt 341 is inserted into the fixing bore 331 of the resilient piece 33 through the hole 318 of the connecting member 31 to screw with the nut 341, thus positioning the resilient piece 33.

The ruler 40 includes a scale 41 defined thereon, the scale 41 includes a number of standard scale codes of papers, such as A4, A5 ect., and the ruler 40 also includes at least one orifice 42.

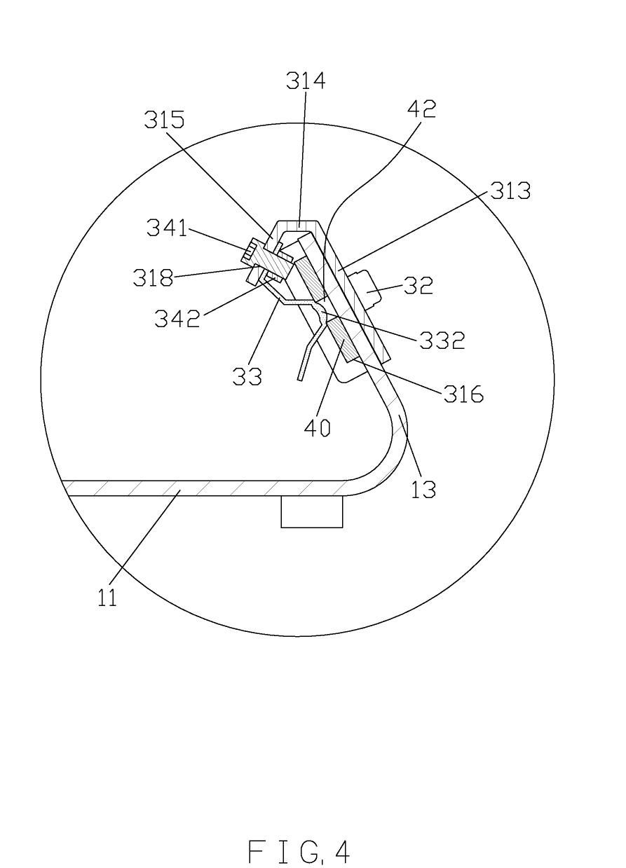

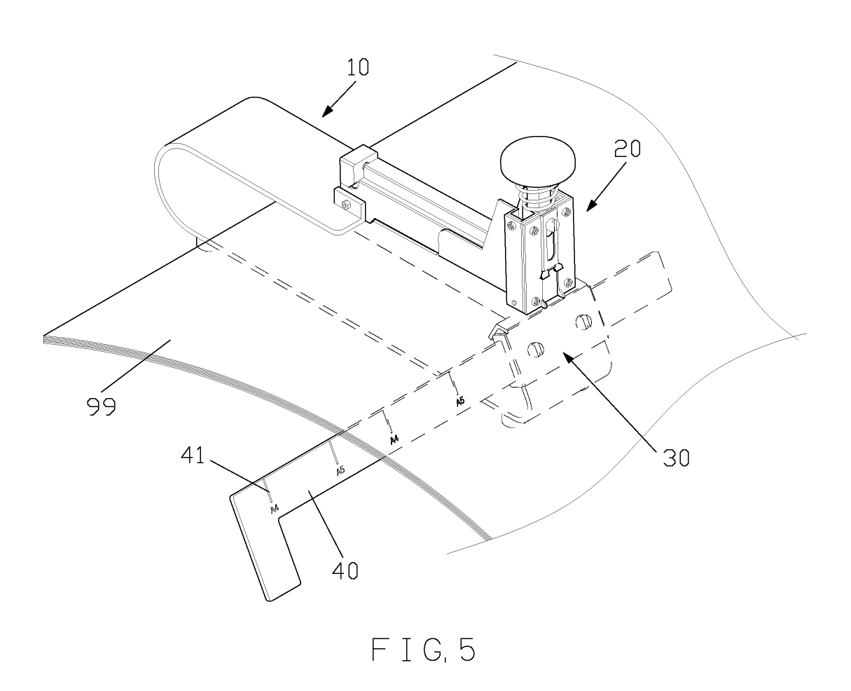

In operation, the ruler 40 is inserted into the horizontal slot 316 of the quick removing assembly 30 so that the positioning projections 332 of the resilient piece 33 retain in the orifices 42 of the ruler 40 as shown in FIG. 4, thus connecting the ruler 40 and the quick removing assembly 30 together to fix the staple at a central position of a paper 99 as illustrated in FIG. 5.

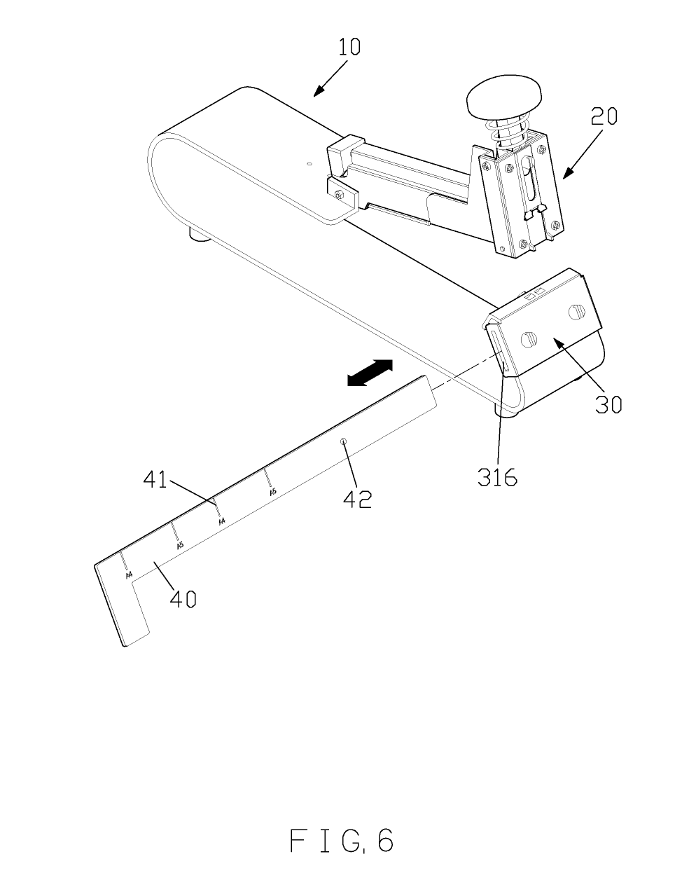

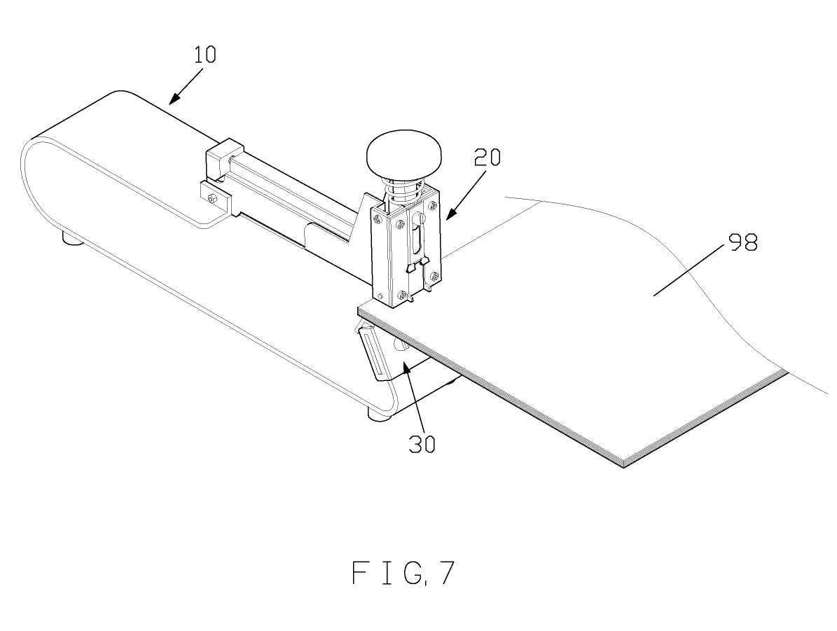

Moreover, when desiring to fix the staple at a peripheral side of another paper 98, the ruler 40 is removed from the horizontal slot 316 of the quick removing assembly 30 as shown in FIG. 6 so that the positioning projections 332 of the resilient piece 33 disengage from the orifices 42 of the ruler 40, thus disassembling the ruler 40 quickly to fix the staple at the peripheral side of the paper 98 as illustrated in FIG. 7.

Also, the staple is capable of being fixed onto the peripheral side of the paper when the ruler 40 is connected with the quick removing assembly 30 without interfacing the filling process of the staples.

Thereby, the ruler 40 is assembled with and disassembled from the quick removing assembly 30 quickly to lower store space and size and to be portable easily.

While we have shown and described various embodiments in accordance with the present invention, it is clear to those skilled in the art that further embodiments may be made without departing from the scope of the present invention.

What is claimed is:

1. A saddle stapler comprising:
a base including a bottom abutting section formed on a bottom end thereof, a top arm section bently extending from one end of the bottom abutting section, a support section obliquely extending upward from another end of the bottom abutting section;
a filling mechanism fixed on an edge of the top arm section of the base to receive at least one type of and one staple, and the staple being forced by pressing the filling mechanism so that it is pushed outward from an outlet of the filling mechanism;
a quick removing disassembly mounted on the support section of the base, and including a horizontal slot and at least one positioning projection;
a ruler including a scale defined thereon, the scale includes a number of standard scale codes of papers, and the ruler also including at least one orifice, the ruler being inserted into the horizontal slot of the quick removing assembly so that the positioning projections retain in the orifices of the ruler, and the ruler being removed from the horizontal slot of the quick removing assembly so that a positioning projections disengage from the orifices of the ruler.

2. The saddle stapler claimed in claim 1, wherein the quick removing assembly includes a connecting member, at least one screwing element, a resilient piece, and a locking unit; the connecting member includes a panel and at least one filling block, and the panel is disposed on the support section of the base by using the screwing elements, and the fitting blocks are connected on the panel, and each fitting block includes a horizontal slot, the resilient piece is fixed on the panel by ways of the locking unit and includes the positioning projections when the resilient piece is not forced, the positioning projections are located at the horizontal slot.

3. The saddle stapler as claimed in claim 2, wherein the panel is bent at a predetermined angle to define a first coupling section, a disassembling section, and a second coupling section, the disassembling section is connected between the first coupling section and the second coupling section at a predetermined included angle, and the fitting blocks are connected on an inner surface of the first coupling section and spaced apart from each other at a predetermined distance, the first coupling section is disposed on the support section of the base by using the screwing elements, and the resilient piece is fixed on the second coupling section of the panel by using the locking unit.

4. The saddle stapler as claimed in claim 3, wherein the second coupling section includes a hole arranged thereon, and the resilient piece includes a fixing bore, the locking unit includes a bolt and a nut, the bolt is inserted into the fixing bore of the resilient piece through the hole of the connecting member to screw with the nut, thus positioning the resilient piece 33.

5. The saddle stapler as claimed in claim 3, wherein the disassembling section includes a recess to remove the staple formed on an outer surface thereof in response to the outlet of the filling mechanism.

6. The saddle stapler as claimed in claim 1, wherein the bottom abutting section is use to put the base on a plane securely, and the bottom abutting section and the top arm section are parallel to each other and spaced away from a certain distance.

7. The saddle stapler as claimed in claim 1, wherein the quick removing disassembly is mounted on the support section of the base to provide a remove groove to bend the staple.
